(19) United States
(12) Patent Application Publication
(10) Pub. No.: US 2019/0205086 A1
(43) Pub. Date: Jul. 4, 2019

(54) IMAGE TAGGING WITH AUDIO FILES IN A WIDE AREA NETWORK

(71) Applicant: Oh Crikey Inc., Carlsbad, CA (US)

(72) Inventor: Stephen Michael McNulty, Carlsbad, CA (US)

(21) Appl. No.: 16/229,443

(22) Filed: Dec. 21, 2018

Related U.S. Application Data
(60) Provisional application No. 62/612,359, filed on Dec. 30, 2017.

(51) Int. Cl. G06F 3/16; G06F 3/0484; G06F 3/0481; H04L 29/08; G06F 16/44; G06F 16/41

(52) U.S. Cl. CPC G06F 3/165; G06F 3/0484; G06F 16/41; H04L 67/02; G06F 16/44; G06F 3/0481

(57) ABSTRACT

Disclosed is a computer implemented internet platform having one or more computer implemented servers connected to the internet with associated non-transient computer readable memory including data storage space resident on non-transitory computer readable media for defining digital spaces available to platform users; the servers include processing circuitry configured for operation with one or more software modules stored on non-transitory computer readable media, the software modules have instructions for processing circuitry to: present user interfaces to at least one platform user that allows access by the at least one user to their digital space for uploading and storing digital images to their digital space; display the uploaded digital images; receive information corresponding to a selected location within the display area of at least one of the displayed digital images from a user; and receive audio and store audio information from a user and associate the audio information with the selected location.

### CROSS-REFERENCE TO RELATED APPLICATIONS

This application claims priority under 35 U.S.C. § 119(e) to U.S. Provisional Application No. 62/612,359 filed on 30 Dec. 2017. The entire content of this provisional application is hereby incorporated by reference in its entirety.

### BACKGROUND

### Field

The present disclosure relates generally to associating file types in a new and unique manner. More specifically, systems and methods for associating digital audio clips with digital images are disclosed herein. In the preferred embodiments, a media file (e.g. a digital audio file) is created and attached to a single pixel location on a digital photo for personalized replay. Thus, in some aspects, a new and improved digital and audio experience can be created, edited, and accessed using the internet.

### Context and Benefits

Digital image sharing is ubiquitous. Most people carry smart phones that include high resolution digital cameras. Captured digital images can be shared between phones, uploaded to photo editing sites, shared on social media sites, stored in the cloud, or manipulated with various applications. Such images can also be tagged with information such as geographical location, user information, or other tags for search optimization and sorting. Facial and object recognition can also be implemented. The present invention allows for additional content, namely audio content, to also be associated with these images. That is to say, the present invention allows one or more users to tag a location within a displayed digital image with one or more digital audio files.

For users desiring to combine digital audio and/or digital audio commentary with digital images, such as photos, the current services available typically require users to combine images and audio into a digital video file format. The resulting video files do not provide users with interactive features such as playback of specific audio recordings assigned to specific locations within an image. Furthermore, current services don't allow users to assign multiple audio recordings from multiple invited guest users to multiple discrete locations within a photo.

Particular implementations of the subject matter described in this disclosure can be implemented to realize one or more of the following potential advantages, among others. Users of the described methods and systems can gain an additional enjoyment experience when viewing photographs—enjoying audio clips that were recorded contemporaneously with a photograph and/or adding audio clips recorded at a later date to photograph taken some time ago. Audio clips from multiple users may be associated with a single image to provide a unique experience when interacting with and sharing photographs with others. The photographs and audio recordings can be saved on one or more networked computers, preserved throughout time, edited over time, and shared with others. Thus, an internet-centric, cloud-based solution is disclosed herein—allowing one to easily associate audio files containing memories or thoughts or observations with one or more digital image files which can in turn be shared and preserved through time.

### SUMMARY

In some embodiments, a web/cloud-based interface (e.g., an internet browser, mobile phone, or tablet application) allows users to upload digital images. The images may be stored on one or more internet connected servers or cloud storage areas. The user may select a X-Y location on the displayed digital image. This selection may also be done using a web/cloud-based interface. This X-Y location may be a specific pixel or group of pixels. In some aspects, this X-Y location corresponds to the position of a specific object or person or area in the scene that is captured by the digital image. While photo tagging of people or object or locations may be common in certain social media applications, the new tagging with audio clips allows for a more unique and enjoyable digital cloud-based photobook.

Once selected, this X-Y location on the image may then be associated with an audio file. The audio file may be pre-existing or recorded contemporaneously when the X-Y location is selected. In some aspects, when the desired X-Y location on the image is selected, the user is prompted to record an audio clip. After the audio clip is recorded, the user may be prompted to provide text that is associated with both the audio file and the desired X-Y location on the image. Thus, in some aspects, when the user or another user maneuvers over the X-Y location (e.g. with a mouse pointer or touch screen input) that was associated with the audio clip and text, the text may be displayed over the X-Y location. In other words, a text tag may be associated with a location within the image and also associated with a specific audio file. In some aspects, when the text is selected by the user, the audio file associated with the X-Y location and the text is played or broadcast for the user to listen to. In other aspects, when the user or another user maneuvers over the X-Y location (e.g. with a mouse pointer or touch screen input) that was associated with the audio clip and text, the audio clip may be played.

Users may make collections of digital images that are or are not associated with audio clips and share these collections or sub collections with others. In some aspects, a user can send another person one or more digital images and ask the other person or user to select locations within the image and record audio clips that are then associated with the selected locations. In some aspects, a user can send another person one or more digital images, select a location within the image, and then ask other people or users to record audio clips that are then associated with the location within the image.

In some embodiments, systems and methods are used to assign digital audio recordings and text labels to a single pixel location within a digital image. A new digital media file format may then be created. The digital media file format can house the digital images, audio recordings, and related pixel location data. That is to say, one unique file may contain at least one digital image that is tagged with at least one audio recording. Such a file may also include text that appears over the tagged location within the image when the image is displayed. Selecting the tag or text tag can result in playback of the at least one audio file.

This digital media file format can be used with an interactive user interface to view and play back the recorded media. The digital media file format can be used with an interactive user interface to invite guest users to add recorded audio and/or text labels (e.g., tags) to said digital images. The resulting media file may be replayed by the image owner and all guests who are invited to share the image. The media files may be stored in a secure online environment and accessed by all invitees using an interactive digital media means. In other embodiments, the media files may be stored on the user's local storage drive, network, smart phone, or the like.

In some aspects, one or more of the following steps are performed. A host may upload a digital photo to a pre-identified secure private space in the cloud. The host may select a pixel (or a specific X-Y location on the image) to associate a tag-like title in text and an audio recording. For example, a host may upload a picture of her and her friends. The host may select as many pixel locations as required to adhere the media to. In other words, the host may select a plurality of pixel locations and tag these locations with as many audio files as they like. In other embodiments, the host may select a pixel area or region of pixels and tag that area with an audio file and/or text file.

The host may select a location on the image that corresponds to a location of her face (or an X-Y location proximity to her face or an X-Y area that approximates the area of her face). She may enter text which may then appear in that location or near that location at all times or when a user is interacting with the image. She may also record an audio recording. The audio recording may be played when the location is selected or interacted with.

In some aspects, the host selects a pixel location and assigns this location to another person (or Guest). The Guest may be identified by their email address, twitter handle, Facebook user name, or the like. The host may assign as many pixels (or a specific X-Y location on the image) to as many Guests as desired. The Guests may receive a notification of the offer to record audio and/or text on the digital image. Said offer may contain a faded representation of the selected photo as an aid to help decide to accept the offer. The Guest may accept the offer and the Guest may record audio and add text labels. The text may include the Guest's name or nickname or user name.

At any point in time, or preferably prior to submitting the audio file, the Host or Guest may play back the audio recording and either re-record the audio or submit it for inclusion in a photo at the selected unique pixel location (“UPL” or a specific X-Y location on the image) which, when submitted becomes the recorded pixel location (“RPL”).

In some aspects, the Host has moderator and administration rights for their photos and may add or remove any associated audio from the photo at their discretion. In some aspects, the Host has full administration rights for the Host's images. In some aspects, the Host and the Host's Guests who have audio recordings associated with the photo may view the image and playback all recordings. In some aspects, the Host has the administration rights to edit any submitted audio. In some aspects, Hosts may download a single instance of the image with recordings to their own unique IP addressed storage device and playback recordings associated with the image. In some aspects, Guests may download a single instance of the image with associated recordings to their own unique IP addressed storage device and play back the recordings. In some aspects, once downloaded to an alternate storage device the image and associated recordings are not editable.

The outcome of this method is the creation of a new media format that combines a digital image with audio recordings provided by multiple users and related to specific locations within the digital image. The new media file can be available for editing and preserved permanently for playback from users with access to it.

Some embodiments include a computer implemented internet publishing platform. One or more computer implemented internet connected servers may have associated non-transient computer readable memory. Data storage space may be resident on non-transitory computer readable media as well. The data storage space may be configured to define a plurality of digital spaces available to a plurality of platform users. Servers may comprise processing circuitry configured for operation with one or more software modules stored on non-transitory computer readable media. In some aspects, the software modules are mobile smartphone applications or web browsers or web browser plugins. The software modules may comprise instructions that cause the processing circuitry to present user interfaces to at least one platform user. Users may access their digital space using the interface and upload digital images to their digital space. The uploaded digital images may be displayed to the user or selected users or guests. Information corresponding to a pixel location on at least one of the displayed digital images may be received from a user using the interface. Audio information may be received and associated with the pixel location. The Audio information may be played when a user selects the pixel location. Text information corresponding to the pixel location may also be received and displayed.

Some embodiments include a system for displaying and archiving digital photos having audio files associated with locations within the displayed digital photos. In some aspects, one or more web servers with associated non-transient computer readable memory comprise data storage space resident on non-transitory computer readable media configured to receive and store digital images and digital audio files. The one or more web servers may be configured to display, when accessed by a web browser, at least one of the digital images and configured to play at least one digital audio file that is associated with a location within the borders of the displayed digital image. The system may also be configured to display text that is associated with the location.

Some embodiments include a web-based system for tagging digital images with digital audio files. The system may include one or more web servers with associated non-transient computer readable memory comprising data storage space resident on non-transitory computer readable media configured to receive and store digital images and digital audio files. The one or more web servers may be configured to display at least one digital image when accessed with a web browser. The one or more web servers may be configured to receive a selected location within the displayed image. The one or more web servers may be configured to receive an audio file that is associated with the location. The one or more web servers may be configured to play the audio file at least when the location is selected.

Some embodiments include a method of tagging digital images with digital audio files. The method may include tagging a digital image file by a selecting a portion of a digital image displayed when the digital image file is accessed or opened and associating an audio file with the selected portion. The audio file may be configured to play when the tag is later selected. The audio file may be a digital audio file.

### BRIEF DESCRIPTION OF THE DRAWINGS

The illustrated embodiments of the disclosed methods, systems, and components are intended to illustrate but not intended to limit the described inventions. From figure to figure, the same reference numerals are used to designate the same components of an illustrated embodiment. The steps or blocks in any flow charts and the like are illustrative only. In some aspects, the blocks or steps may be rearranged, repeated or omitted. The following is a brief description of each of the drawings.

FIG. 1 is an organization diagram illustrating an exemplary overview of system architecture that can be used to embody one or more of the disclosed inventions.

FIG. 2 is a flow chart illustrating an exemplary system for practicing one or more of the disclosed inventions. An exemplary flow for a photo Host Interface and an exemplary flow for a Guest Device Interface are shown. While shown in a particular order, many steps may be re-arranged, added, or omitted.

FIGS. 3-8 show screen shots of a web-based prototype that the inventor created to embody one or more of the disclosed inventions.

### DETAILED DESCRIPTION OF THE PREFERRED EMBODIMENTS

The present invention includes a method for assigning a digital audio recording and, in some aspects, text labels to a location within a digital image. The location may comprise a single pixel or a group of pixels. The invention also includes a method for creating a new media file format (or platform or mobile application and the like) that houses digital images, audio recordings, and related image location data. The invention may provide an interactive user interface for viewing and playing back the recorded media. The invention may also provide a way of storing, viewing, and sharing data that when accessed, displays a digital image and allows areas within the image to be tagged with audio clips that can be recorded and added to the image or broadcast and listened to by viewers of the image.

The present invention is different from other post-capture digital image services because it attaches an audio file to a location in a photo (e.g. a pixel within a digital image) and preserves that photo and associated media as a point in time for as long as the owner desires. It is also different as it allows multiple users to contribute to a single photo via uniquely selected pixel locations at any time—from the moment the photo is captured and on—thus making it permanently editable and a sort of time capsule for viewing, listening, and commenting on.

In some aspects, the systems and methods attach digital audio files and associated text files to a single pixel on a photo and allows hosts and/or guests to manipulate these audio and text files and replay them at any time and from anywhere. As such, images may remain in current real-time for all hosts and guests and is not transient but is rather a living file with longevity.

Host users may invite guest users to record audio and add text labels to digital images as well. The resulting media file can be replayed by the image owner and all guests who were invited to share and add audio content to the image. The media files may be stored in a secure online environment and accessed by any and all interactive digital media means.

While generally described as a web-based system for storing, marking up, and displaying the digital images and recording/replaying digital audio that is associated with the selected portions of the digital images, other solutions are also contemplated. For example, the invention could be implemented with software that is executable on a personal computer or by using smart phone application. In some aspects, a unique file type is created. The file type may be configured to display digital images and play digital audio when the file type is executed by compatible software.

The invention may include a secure digital storage area in the cloud. Users may access their secure digital storage areas through the internet or other wide area or local network. Each user may have a unique identifier. Hosts may have host identifier and guests may have guest identifiers. Users (hosts and guests) may be given access to certain storage areas. An interface may be presented to users that allows them to upload digital photos. The interface may be web based or application based. An interface may allow the photos to be displayed, organized, and shared. An interface may allow for users to select an X-Y location or pixel on image that was previously uploaded.

An interface may allow the user to add text or add a tag related to the selected X-Y location. An interface may also allow for a user to associate a digital audio file or other media file to the selected X-Y location. The interface may display a prompt to record an audio clip. The interface may allow for the recorded audio clip to be edited and reviewed. The interface may allow for the recorded audio to be finalized and associated with the selected X-Y location. The interface may allow for the recorded audio to be replayed to the user and/or to the user's guests. The interface may allow other users to similarly tag locations on the digital images with text and/or audio and/or other media files. The interface may allow other users to grant access to one or more of their uploaded digital images to allow for editing and adding new tags and text and audio clips.

In some aspects, a system is provided for downloading of the completed photo and associated media to local storage for local replay. The system may allow for the photo and associated media to be moderated by the user who originally uploaded the photo. The system may provide one or more digital spaces that house the photos and associated media associated with the photos. Each user may have its own digital space where they can moderate the photos and the associated media that is within the user's own digital space. The system may be used to add the media (e.g. the audio clip) at the same time the digital photo is created. In some aspects, the captured audio clip includes background sound integration to recapture the mood of the event that the photo captures.

The system may include automated person, place, or thing recognition in each photo using recognition software scanning. Facial recognition software may also be implemented. Other imaging techniques may be implemented as well (e.g. image editing, image filters, contrast adjustment, 3D images, panoramic photos, composite photos, etc.). The system may be capable of recognizing QR codes or barcode. For example, such codes may provide access to a previously uploaded photo for applications in museums and galleries. The system may include search functionality to allow for users and/or guests to find photographs using search terms for tags or people or places or objects associated with or found in the actual images. The system may include written and spoken language filters that can change the available text and audio that is displayed to users. Uploaded photos may include or be tagged with time stamp information relating to when the photo was taken, uploaded, edited, and shared. In this way, the system may include leaf back in time functionality. The system may be configured to interface with smart TV's or other such equipment.

In some aspects, when a location on an image is selected by the user, the system prompts the user for text input from the user. After receiving the text, the system may prompt the user to record an audio clip. The user may record the clip. The recording may be stopped automatically or stopped by the user. The audio may be reviewed by the user. Once approved, the audio may be associated with the selected location on the image. If the audio recording it not approved, it may be re-recorded until finalized and approved. In some aspect, multiple audio files may be associated with the same image location.

In some aspects, a user may invite a guest to record an audio clip that is associated with a location that the user selected on the image. The system may allow the user to attach the photo to an email that is sent to the guest along with an invitation to tag the photo with an audio clip. In some aspects, the email includes a preview of the image. In some aspects, the email may include a link that directs them to the server where the photo is displayed, the image is tagged, and the audio clip is associated with the tag. In some aspects, the system may be integrated with other commercially available digital delivery and replay systems or social media platforms.

In some aspects, the system may allow for groups of users to access a single photo and edit and comment and tag and record audio files that are associated with various X-Y locations on the image. The system may also allow for a “Now and Then” feature that rotates photos with photos taken of the same thing, person or place at differing times. The system may allow for groups of users to share and link to and discuss the images and associated audio clips.

In some aspects, a user can access their digital space via a user interface that connects through an internet connection to a specific URL. In some aspects, an internet connected server may host a web application written in C+ and built using asp.net running on top of .net core 2.0. Several Microsoft Azure services may host the application and database along with an Azure blob storage for persisting pictures and Media files. Microsoft SQL server database may be used as a primary data store. Host and Administrator authentication/authorization may be handled using asp.net core identity. The systems may send emails using SMTP to communicate to a commercial email service called SendGrid.

The front-end portion of the system may be written using a mix of html, css and JavaScript. Other software languages may also be used. The invention in all its forms may have systems that allow third party hosts to access the method via specially designed application protocol interfaces (APIs), allowing the third party to self-brand the host experience without the need to host the method or the system separately.

In some embodiments, a photo owner accesses an online portal and requests registration. The photo owner may be granted registration and is now termed a Host. The Host may be given unique Hostname and password. The Hostname and password may be required to access the method and system moving forward. The Hostname and password may grant the Host access to the Host's own digital space for curating the Host's digital images. In this way, the method and system implement a new host protocol and allocate the Host an initial photo album area that is specific, private, and confidential to that Host. The Host's album may contain either unlimited or limited photos dependent on type of host experience the Host wishes to create.

The Host Album may include a user interface or home page that contains one or more of the following methods and systems. There may be a system for the Host to commence the upload of a Photo. The system may allow for the host to sort, add, delete, edit, organize, display thumbnail or full-sized photos, and the like. Sub-albums may be created and labeled.

In some aspects, the Host may wish to upload a new photograph by selecting a menu button that is displayed on the user interface or home page. For example, the Host may select an “+” sign on the home screen and may then be provided with an upload graphic which, when selected, opens a “pop up” page requesting the Host to either “drag & drop” a photo or select one from their files. In this way, the Host selects the desired photo and it is uploaded to the system. The Host may have an option of entering the date (or estimated date) that the photo was captured and this may tie in with the chronology of the photos and the “leaf-back” in time facility. The uploaded photo may then be shown as a thumbnail in the Host's album.

The Host may select an uploaded photo to open a photo editing screen. The photo editing screen may include icons such as: “Add Photo Tag” (which allows the Host to record audio and add a text title to the photo), “Delete Photo Tag” (which allows the Host to delete the Media and text title from the photo). Another icon may be used to toggle the display of the text tags on and off. Another icon may include a start icon for replaying all of the audio recordings associated with the photo.

After selected pixels (or X-Y locations) in the photo are associated with an audio recording the single pixel recording may be represented by an icon along the bottom bar. This may allow for a single audio recording to be replayed one at a time. The single pixel audio recording may also be replayed by selecting the pixel location that was associated with the audio recording.

The Host may select any pixel (or X-Y location) in the photo by, for example, “clicking” on it. In some aspects, after clicking the desired location on the photo, the Host is presented with an icon representing a microphone or other such prompt. Choosing this icon may allow the Host to record a digital audio file that is stored and associated with the pixel that was selected. In some aspects, after the audio is recorded, the Host is prompted with a text box. The Host may enter text. This text may then be associated with the pixel that was selected as well. These text boxes may be displayed over or near the pixels at all times, or hidden, or may be displayed when interacted with.

In some aspects, the Host may also be allowed to select an icon that represents a person. Choosing this icon may allow the Host to “tag” someone else. Tagging someone in this way may invite them to record an audio file on that pixel (and optionally add an associated text title). The person may be invited by providing their Hostname (if they are registered) with the system, or by providing their email address. The person identified as being invited to add an audio recording to the selected pixel may receive the invitation either within the system architecture (as a previously registered user) or via email which may include the invite and a faded copy of the subject photo. The email may also include a link to the pixel specific location on the photo selected by the Host. The invited person may accept the invitation or decline.

If the invited person accepts the invitation, the system may open up the option of continuing as a guest or of becoming a registered user of their own. It is to be noted that when the invited person becomes a registered user, he is still a guest to the photo that remains primarily under the control of the Host who sent the invitation. The latter of the above takes the person to the “Register” screen and, once registered, back to the photo. Once the invitation from the Host is accepted by the invited person they may be transferred to the specific pixel of the photo in the method and system where they may have the following options: they may listen to the audio files already recorded and available for playback on the system via the method and/or complete an audio recording and associated text file. Prompts may be displayed as pop-ups when the associated text file is being compiled and audio file is recorded. Once the audio recording is completed the recorder may listen to the recording and can re-record as many times as they wish prior to submitting the audio and associated text file for attachment to the selected pixel on the selected photo.

Although the audio file is immediately attached to the pixel, the Photo Owner (or Host) may have full moderation rights and can delete any audio and associated text at their sole discretion. Invited persons may only access the photo that they are invited to view and record audio only to the pixel location allocated to them by the Photo Owner. Once the Media and associated text files are submitted for attachment to the pixel the invited person may return to the photo at any time and listen to audio recordings associated with pixels on that photo. In some aspects, invited guests no longer have editing rights at this stage. In some aspects, the owner maintains the photo in his or her digital space, such that the photo is available to all users who have contributed audio recordings and associated text labels to it. Once the Photo Owner removes the photo from their album, access is lost to everyone.

In some aspects, in order to keep the memories associated with a photo, the Photo Owner may request a download of the photo and associated Media and text files to their personal storage space. The method and system may provide for this external download on a single IP address basis and may provide an “in photo” playback system via a Web App available from the system.

In some aspects, a mobile application may allow for the Media and text files to be recorded at the time the photo is captured by numerous persons via Bluetooth connectivity. The photo owner may retain the right of moderation and the ability to invite others at any time after the initial event. In circumstances where a group Media recording (e.g. debate or discussion or the like) is required to be attached, the invention may allow the photo owner to attach numerous Media files to the pixels immediately surrounding the original selected pixel. For example, the Photo owner may select groups of people and multiples of people as they wish.

In some aspects, the system may be configured to allow the photo owner to allocate as many tags as there are pixels in the photo. The Host may create as many albums as they wish and may include the same photo in different albums. The Host may delete their albums at their discretion. If they wish to do this the system may be configured to ask whether the photo owner wishes to offer the completed recorded photo to be offered to the other people who have recorded Media on the photo.

In some aspects, any user can, with the photo owner's approval, download a local copy of the photo with the associated Media and text files. The method and system may provide for this external download on a single IP address basis and provides an “in-photo” playback system via a Web App. In some aspects, this photo and its associated Media and text files cannot be edited.

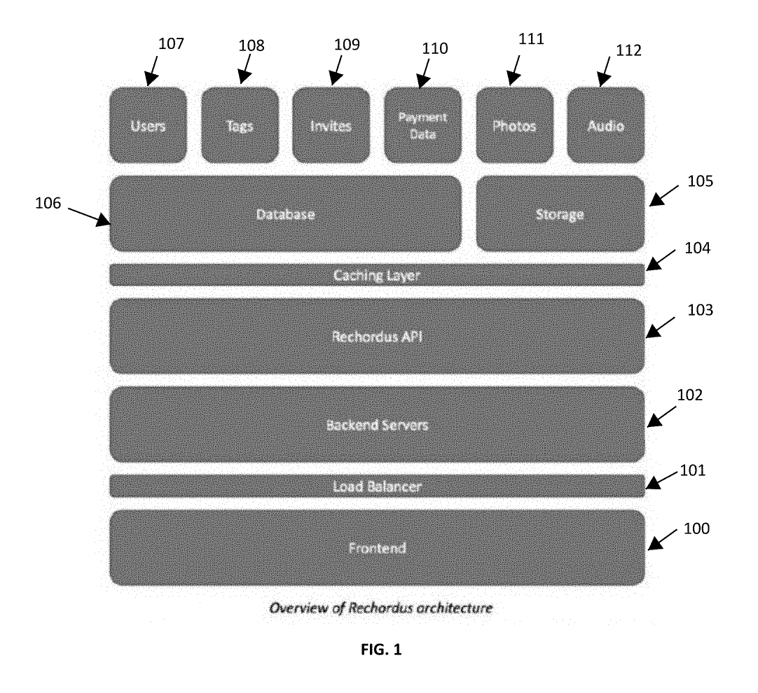

Turning to FIG. 1, an organization diagram illustrating an exemplary overview of system architecture that can be used to embody one or more of the disclosed inventions is shown. This diagram gives an overview of the architecture of prototype of the invention referred to as “Rechordus.” As shown, a frontend 100 may comprise one or more software modules or a web browser interface or mobile phone application that is presented to users. The frontend 100 may allow for users to, for example, upload or download digital images, interact with digital images already within the system, add or edit or listen to audio to the digital images, and tag digital images with text and/or audio files. Information can flow through one or more load balancers 101 to one or more backend servers 102. The Rechordus API 103 may reside on the backend servers 103 which may also include a caching layer 104, a database 106, and a storage location 105. Information on the database 106 and/or storage 105 may include user information 107, tag information 108 (e.g. location and/or text), invite information 109, payment information 110, photo information 111, and audio information 112.

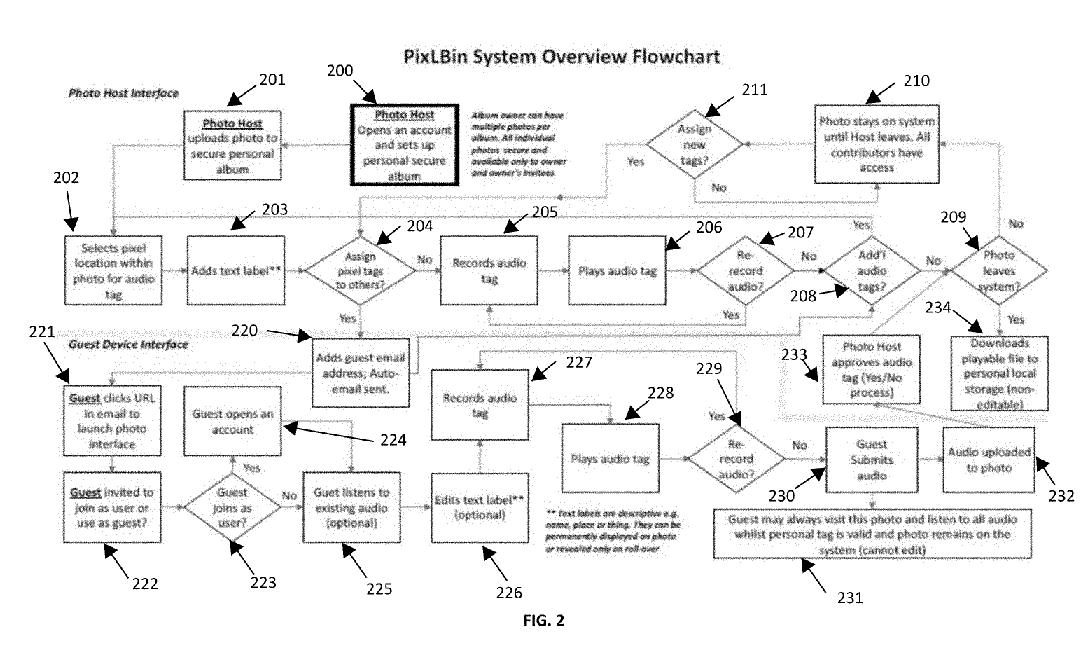

As shown in FIG. 2, a user may upload a digital photo to their digital space. The user may select a location within the borders of the displayed and uploaded digital photo. The location may be a pixel or a cluster of pixels. In some aspects, the location may be a displayed area, or portion of a displayed image rather than a unique pixel. For example, the location may be the portion of the digital image that displays a person or part of a person (e.g., a person's face). The user may then supply text that is associated with the selected location. The location may be assigned to other guests who may then supply or edit the text label. The user and/or invited guest may then record a digital audio file, or provide a pre-recorded digital audio file. This audio file is then associated with the location within the borders of the displayed photo and the text. When the photo is viewed by the user or other guests, the text may appear above, or near, or adjacent to the selected location. The audio file may play when the text is selected or when the location or area adjacent to the location is selected.

Continuing with FIG. 2, at block 200, a host may open an account and set up a secure digital space. The digital space may house digital images that are created by the host. At block 201, the host may choose to upload a digital image to his secure digital space. At block 202, the host may select a location within in the uploaded digital image and tag this location. This location may then be associated with text and/or a digital audio file. At block 203, the host may add text to the tag at the location. At block 204, the host me choose to assign this tag to another user. Should the host not choose to assign this tag to another user, the host may proceed to record audio that may be associated with this tagged location within the uploaded digital image. After recording the audio, the host may play the audio at block 206. At block 207, after listening to the recorded audio, the host may choose to re-record the audio or accept the original recording. The host may then choose to add additional tags at block 208. If so, the host can return to block 202. If the host chooses not to add additional tags at block 208 the host may either download a new file type having the digital image, location tag within the digital image, and text and audio associated with that tag at block 234 or may choose to leave the enhanced digital image on the system as shown at block 209. This image, tag, and text/audio associated with the tag may the remain on the system (e.g. stored on the cloud) until the host leaves the system as shown in block 210. The host may decide to assign new tags as shown in block 211.

If the host chooses to assign the tag to another user at block 204, the host me provide a guest email address at block 220. An invite will then be sent to the guest. The invite may comprise an email sent to the email address. The email may include a URL that links the user to an interface where the digital image and tag is displayed to the guest. If the guest accesses the URL at block 221, the digital image and tag is displayed to the guest in a phot interface. The guest may be invited to join the system as a user or continue on as a one-time or infrequent guest at block 222. If, at block 223, the guest wishes to become a user, the guest may open an account with the system at block 224. In the alternative, the guest may choose not to register as a user and may continue to view the image and the tag and optionally listen to the audio associated with the tag at block 225. At block 226, the guest may choose to edit the text associated with the tag. At block 227, the guest may choose to record audio. At block 228, the guest may listen to the recorded audio and may choose to re-record the audio at block 229. Once the audio is approved, the audio may be submitted at block 230. As noted in block 231, the guest may be able to continue to access the digital image, tag, and associated text and audio recording but may no longer edit the content. At block 232, the audio may be uploaded to the system and the host may review the audio to approve or disapprove of the content provided by the guest at block 233.

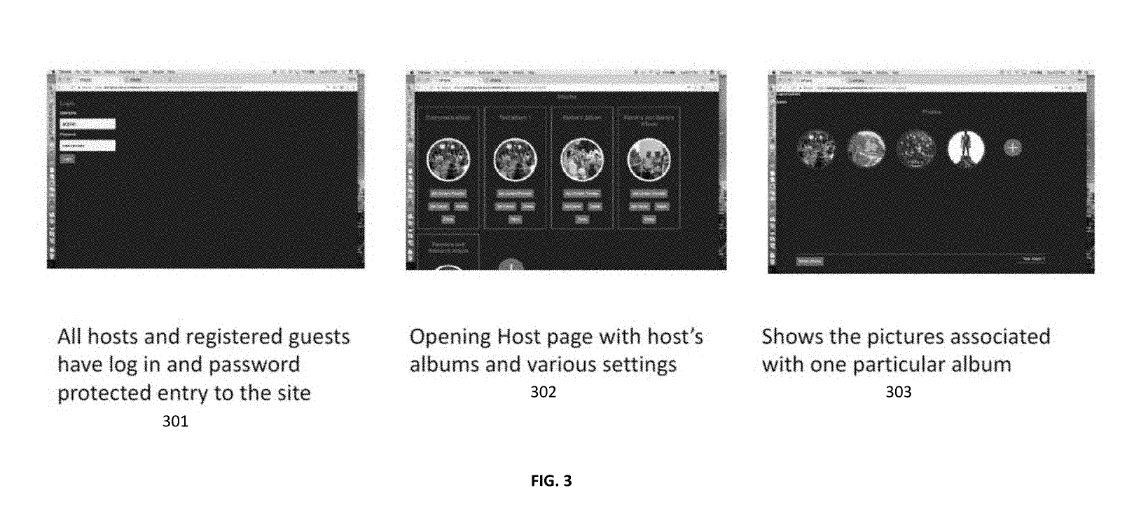

FIGS. 3-8 show screen shots of a web-based prototype that the inventor created to embody one or more of the disclosed inventions. Starting with FIG. 3, 301 depicts a sample user interface showing a host and/or registered guest login screen. After logging in, the host and/or registered guest may access and view the secure media content associated with their account. The content may be organized as albums of multiple images. As shown in 303, pictures may be selected to be displayed in connection with an album (or collection) of images.

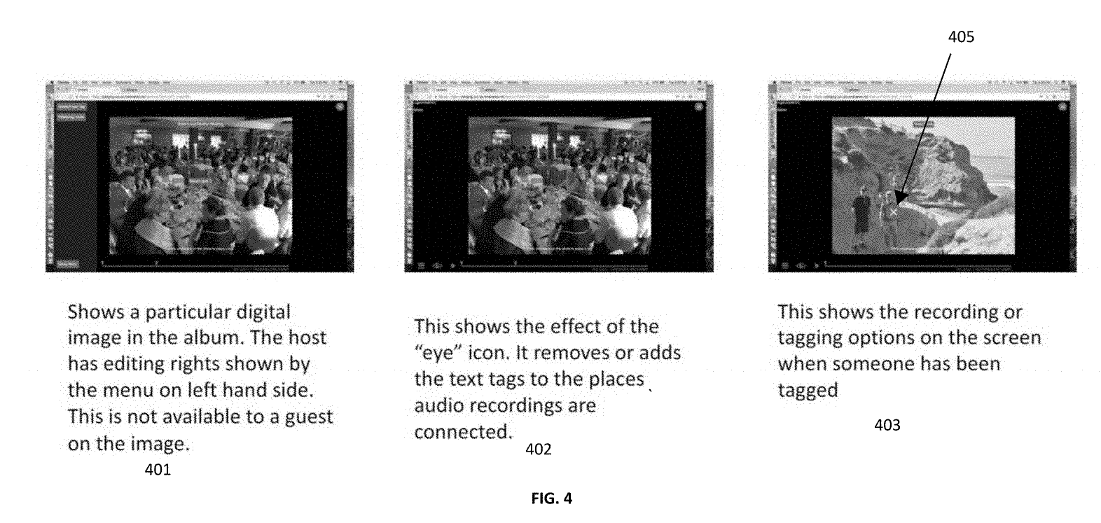

Turning to FIG. 4, a particular image may be selected from an album and displayed to the host and/or registered guest at 401. If the host or registered guest has editing rights a menu may be displayed along with the image. The menu can act as an interface and allow host and/or registered guests to tag images, add text associated with the tags and record and listen to audio associated with the tags. After selected an editing icon, for example, an “eye icon” the user may add tags, or select tags, or edit the text associated with tags at 402.

As shown, in the far-right panel of FIG. 4 at 403, a user may select a location within a displayed digital photo. In this instance one of the hikers in the photo has been tagged as seen by the “X” in the photo 405. This location may then have text and an audio file associated with this tagged location. For example, the text may indicate the name of the hiker and the audio file may record and replay the thoughts that this hiker had on this day. This particular hiker may wish to also have his friend to the right record an audio file that is associated with his location in the displayed photo. As such, he may tag the other hiker and invite the hiker to record an audio file. Later, when the photo is displayed and viewed, users may be able to view the photo and listen to the thoughts associated with the tagged locations (e.g. people and objects) within the photo.

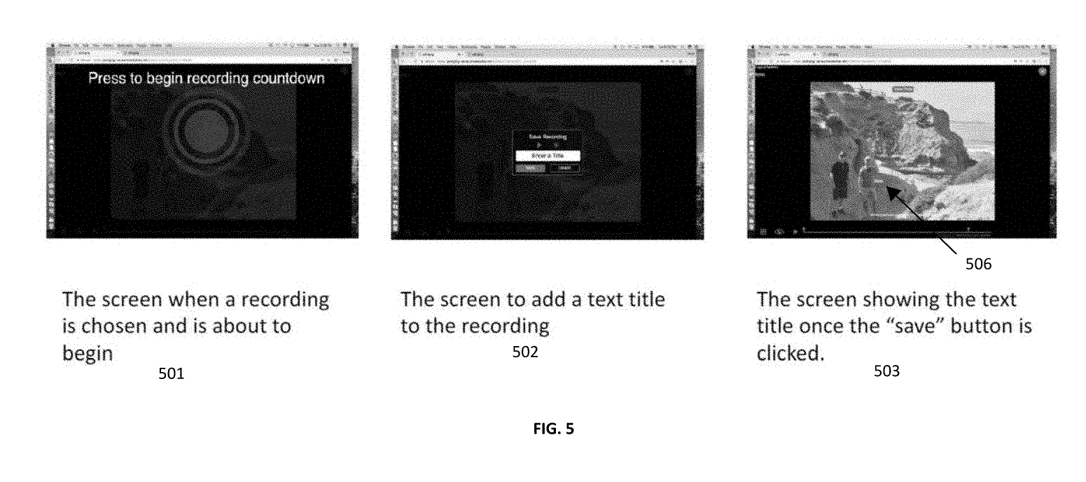

Moving to FIG. 5, the interface may display a countdown screen 501 which prompts a user when to begin recording the audio. After the audio is recorded, the audio may be labeled with text displayed as shown in screen 502. In some aspects, this text may be displayed at or adjacent to the tagged location within the digital image. For example, the audio file may be named “Steve.” As shown in the far-right panel of FIG. 5, the text tag “Steve” 506 may be displayed over the digital image in an area adjacent to the location that was previously tagged in far-right panel of FIG. 4 as shown by the “X” in the photo 405. This image, now tagged with a location that is in turn associated with text and audio may then be saved as shown in 503.

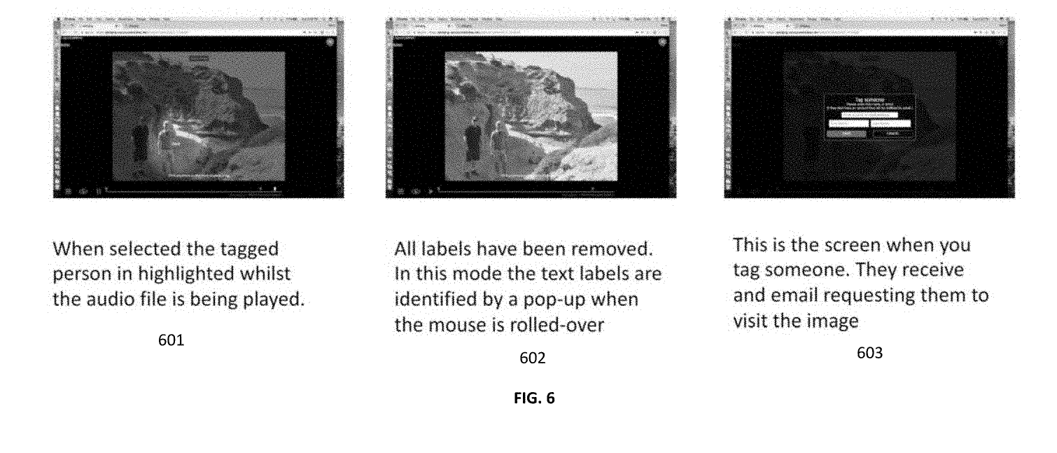

As shown in the far-left panel of FIG. 6 at 601, when the text is selected, or when the area near the tag is selected, a relevant image area may be highlighted 610 and the recording may be played. The interface may allow for the text labels to be turned off and not displayed as shown in 602. 603 depicts an interface that allows a user to tag another person and provide that person's email address.

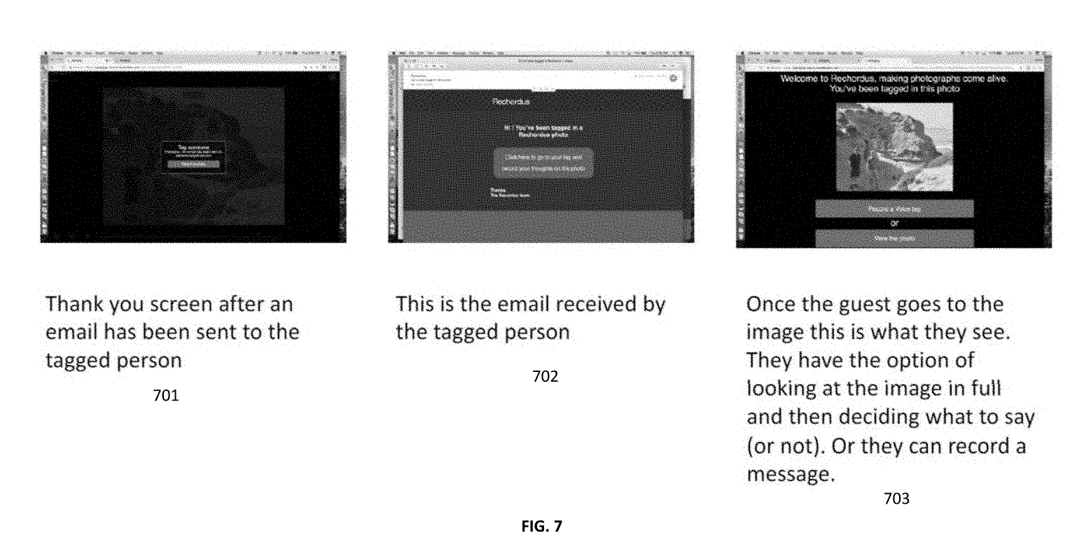

Turning to FIG. 7, after another person in the image is tagged and an email is provided, the user may be displayed an acknowledgment screen as shown in 701. 702 depicts a sample email received by the invited guest. The guest may access a URL in the email and be re-routed to a screen as shown in 703. The guest may be presented the option of recording audio to be associated with the image or viewing the image.

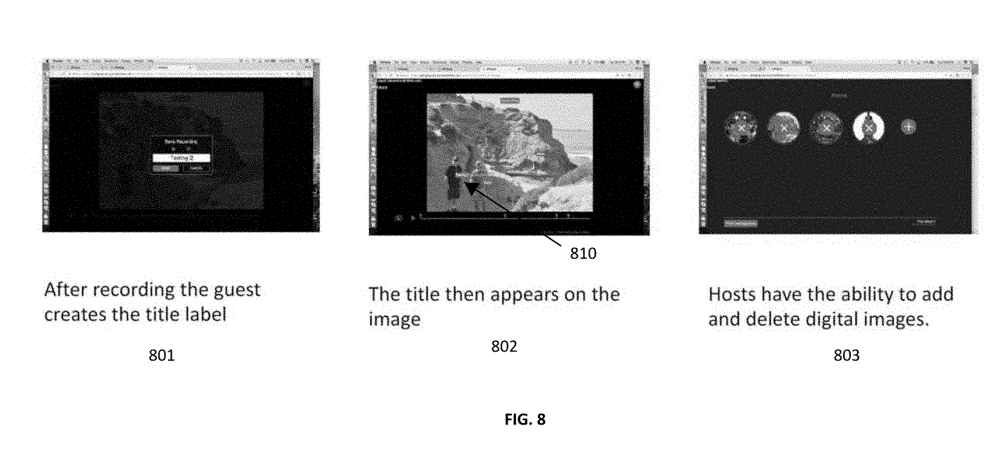

Turning to FIG. 8, the guest may choose to record audio and may then be presented with the display shown in 801 that prompts the guest for a text label for the audio recording. The title of the audio may then be shown over or adjacent to the tagged person (the man 810 to the far left in 802). Hosts may add new images with the +interface in 803 or remove images with the X in 803.

The foregoing description details certain embodiments of the systems, devices, and methods disclosed herein. It will be appreciated, however, that no matter how detailed the foregoing appears in text, the devices and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated. The scope of the disclosure should therefore be construed in accordance with the appended claims and any equivalents thereof.

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

It is noted that the examples may be described as a process or a system. Although the operations may be described as a sequential process, many of the operations can be performed in parallel, or concurrently, and the process can be repeated. In addition, the order of the operations may be rearranged. A process may correspond to a method, a function, a procedure, a subroutine, a subprogram, etc.

The previous description of the disclosed implementations is provided to enable any person skilled in the art to make or use the present disclosed process and system. Various modifications to these implementations will be readily apparent to those skilled in the art, and the generic principles defined herein may be applied to other implementations without departing from the spirit or scope of the disclosed process and system. Thus, the present disclosed process and system is not intended to be limited to the implementations shown herein but is to be accorded the widest scope consistent with the principles and novel features disclosed herein.

What is claimed is:

1. A computer implemented internet platform comprising:
one or more computer implemented servers connected to the internet with associated non-transient computer readable memory comprising:
data storage space resident on non-transitory computer readable media configured to define a plurality of digital spaces available to a plurality of platform users;
wherein the servers comprise processing circuitry configured for operation with one or more software modules stored on non-transitory computer readable media, wherein the software modules comprise instructions that cause the processing circuitry to:
present user interfaces to at least one platform user that allows access by the at least one user to their digital space for uploading and storing digital images to their digital space;
display the uploaded digital images;
receive information corresponding to a selected location within the display area of at least one of the displayed digital images from a user; and
receive audio and store audio information from a user and associate the audio information with the selected location.

2. The platform of claim 1, wherein the software modules further comprise instructions that cause the audio information to play when one of the plurality of users later selects the selected location.

3. The platform of claim 2, wherein the software modules further comprise instructions that cause the processing circuitry to receive text information corresponding to the selected location and display the text information when the location is selected.

4. The platform of claim 3, wherein the software modules further comprise instructions that allow a host user to invite at least one guest user to provide the received information corresponding to the selected location and provide the received audio information associated with the selected location.

5. The platform of claim 4, wherein the software modules further comprise instructions that allow a user to review the received audio prior to storing the received audio.

6. A web-based system for tagging digital images with digital audio files:
one or more web servers with associated non-transient computer readable memory comprising data storage space resident on non-transitory computer readable media configured to receive and store digital images and digital audio files, the one or more web servers configured to:
display at least one digital image when accessed with a web browser;
receive a selected location within the displayed image;
receive an audio file that is associated with the location; and
play the audio file at least when the location is later selected.

7. The web-based system according to claim 6, wherein the one or more web servers is further configured to receive text that is associated and displayed with the selected location.

8. The web-based system according to claim 7, wherein the one or more web servers are further configured to receive a plurality of selected locations within the displayed image and receive a plurality of audio files that are associated with the plurality of selected locations.

9. The web-based system according to claim 8, wherein the one or more web servers are further configured to electronically send at link to a guest, the link configured to display the at least one digital image to the guest when the link is accessed.

10. The web-based system according to claim 9, wherein the one or more web servers are further configured receive another selected location within the displayed image from the guest, receive another audio file that is associated with the location received from the guest, and play the audio file at least when the selected location is later selected.

11. A method of tagging digital images with digital audio files comprising:
tagging a digital image file with a tag by a selecting a portion of a digital image displayed when the digital image file is accessed; and
associating a digital audio file with the tag, wherein the audio file is configured to play when the tag is later selected.

12. The method of claim 11, wherein the digital images are stored on internet connect servers.

13. The method of claim 12, further comprising prompting a user for text that is associated with the digital audio file or the selected portion when tagging.

14. The method of claim 13, further comprising displaying the text in the displayed digital image.

15. The method of claim 13, further comprising sending access to the digital image to a guest who is allowed to tag a location within the digital image and record audio associated with the tagged location.
